(19) United States
(12) Patent Application Publication
(10) Pub. No.: US 2015/0139884 A1
(43) Pub. Date: May 21, 2015

(54) PROCESS FOR PREPARING MIXED ALKALI METAL PYROPHOSPHATES

(71) Applicant: Innophos, Inc., Cranbury, NJ (US)

(72) Inventors: Arbnor Ibraimi, Wanaque, NJ (US); Robert Clyde Finn, Westfield, NJ (US)

(73) Assignee: INNOPHOS, INC., Cranbury, NJ (US)

(21) Appl. No.: 14/083,337

(22) Filed: Nov. 18, 2013

(51) Int. Cl. C01B 25/168

(52) U.S. Cl. CPC C01B 25/168; C01P 2002/72
USPC 423/306

(57) ABSTRACT

The present invention relates to a process for preparing a mixed alkali metal pyrophosphate comprising spraying a mixed orthophosphate into a recycling bed of mixed alkali metal pyrophosphates at a kiln temperature of 350 C to 550 C.

### BACKGROUND OF THE INVENTION

(1) Field of the Invention

The present invention relates to a process for preparing mixed alkali metal pyrophosphates.

(2) Description of the Related Art

It is well-known to those skilled in the art that blended salt pyrophosphates can be prepared by mechanically blending previously prepared materials such as Na₄P₂O₇and K₄P₂O₇. U.S. Pat. No. 2,511,249 describes the problems with these mechanical mixtures and discloses a chemical process for preparing sodium potassium pyrophosphates. Specifically, said process comprises mixing a 50% solution of Na₂HPO₄with an approximately 46% solution of K₂HPO₄ in the proportions adapted to supply 50.3 parts by weight of Na₂HPO₄ to 49.7 parts by weight of K₂HPO₄, drum drying the resulting mixture and then heating the dried material at greater than 350 degrees centigrade to the pyrophosphate forming temperature to produce a product consisting essentially of Na₂K₂ P₂O₇, said product being characterized by having a substantially improved solution rate and resistance to moisture vapor absorption over the corresponding mechanical mixture of Na₄P₂O₇ and K₄P₂O₇.

U.S. Pat. No. 4,798,712 also describes the problem with physically blending sodium polyphosphates such as sodium pyrophosphate, sodium tripolyphosphate and sodium meta-phosphate. US 712 discloses the following chemical process for making alkali metal pyrophosphates:
1. Forming an aqueous solution of alkali metal orthophosphates having an alkali metal to phosphorus mole ratio in the range of from 5 to 3 to 6 to 3;
2. Flash drying the solution at a temperature of from 150 C to 550 C to form phosphate particles;
3. Calcining the dried particles at a temperature of about 350C to 550C to convert the particles into polyphosphate particles.

The flash drying step can be accomplished using a drum dryer or spray dryer. The calcining temperature of 350C to 550C converts the orthophosphates into polyphosphates.
U.S. Pat. No. 5,302,363 also describes a chemical process for preparing mixed alkali metal polyphosphates. Said process includes the steps of:
a. preparing a solution of at least two different alkali metal orthophosphates salts
b. drying the mixed salt solution by spraying the solution onto a timely bed of mixed phosphate salts
c. Calcining the dried salt mixture at a temperature in the range of from about 350° C. to about 600° C. to form an alkali metal polyphosphates salt mixture containing at least two different alkali metal cations.

An article in the J. Agric. Food Chem describes a low temperature condensation process of a mixture of potassium, sodium and calcium phosphates. Soluble condensed phosphates were obtained as products, mainly consisting of pyro and tripoly or tripolyphosphates and the created crystalline phases were the suitable solid solutions of potassium-sodium pyro and tripolyphosphates: (K,Na) ₄P₂O₇ and (K Na)₅P₃0₁₀.

See, Grzmil, B. “Manufacturing of Neutral Sodium Potassium Pyro and Tripolyphosphates as Complexing Agents of Nutrient Microelements”, J. Agric. Food Chem. 1997, 45, 4877-4883.

Now, Applicants have improved on the art by developing a one step process for preparing mixed alkali metal pyrophosphates. Said mixed alkali metal pyrophosphates have a distinctive X-Ray Diffractometer (XRD) pattern that distinguishes them from mixed alkali metal pyrophosphates that are prepared by mechanically blending previously-produced Na₄P₂O₇ and K₄P₂O₇. Said mixed alkali metal pyrophosphates have a wide range of applications in the food industry and in industrial chemicals. For example, the mixed alkali metal pyrophosphates of the present invention are useful in reduced sodium food applications, detergency builders, and as pet food palatants. These mixed alkali metal pyrophosphates are also useful as dispersants.

### BRIEF DESCRIPTION OF THE DRAWINGS

FIG. 1—FIG. 1 is the process flow diagram of the present invention

FIG. 2—FIG. 2 is an X ray diffraction pattern showing the mixed alkali metal pyrophosphate of the present invention.

### SUMMARY OF THE INVENTION

The present invention relates to a process for preparing a mixed alkali metal pyrophosphate compound having the formula:

X₂Y₂ P₂O₇

wherein X and Y are independently selected from the group consisting of Na, K, Li, and Cs comprising spraying a mixed orthophosphate into a recycling bed of mixed alkali metal pyrophosphates at a kiln temperature of 350C to 550C.

The present invention further relates to a process for preparing a mixed alkali metal pyrophosphate compound having the formula:

Na₄K₄(P₂O₇₎₂comprising spraying water into a mixed bed of Na₄P₂O₇ and K₄P₂O₇.

### DETAILED DESCRIPTION OF THE INVENTION

The present invention relates to a process for preparing a mixed alkali metal pyrophosphate compound having the formula:

X₂Y₂ P₂O₇

wherein X and Y are independently selected from the group consisting of Na, K, Li, and Cs comprising spraying a mixed orthophosphate into a recycling bed of mixed alkali metal pyrophosphates at a kiln temperature of 350C to 550C.

The present invention further relates to a process for preparing a mixed alkali metal pyrophosphate compound having the formula:

Na₄K₄(P₂O₇₎₂ comprising spraying water into a mixed bed of Na₄P₂O₇ and K₄P₂O₇.

### Definitions and Usages of Terms

“Recycling Bed”—The process of the present invention is carried out in a kiln. Specifically, in the external recycle portion of the kiln, a portion of the mixed salt product is sent forward as a finished mixed salt product and the remainder is re circulated back to the feed end to form the “recycling bed”.

“Mixed orthophosphates”—Those skilled in the art understand that orthophosphosphates are the salts or esters of phosphoric acid. For example:

1H₃PO₄+NaOH—NaH₂PO₄+H₂O

2H₃PO₄+Na₂CO₃—2NaH₂PO₄+H₂O+CO₂

NaH2PO4+KOH—NaKHPO4+H2O

Na₂HPO₄ and K₂HPO₄ are physically mixed

The following non limiting examples illustrate the practice of the present invention:

### Example 1

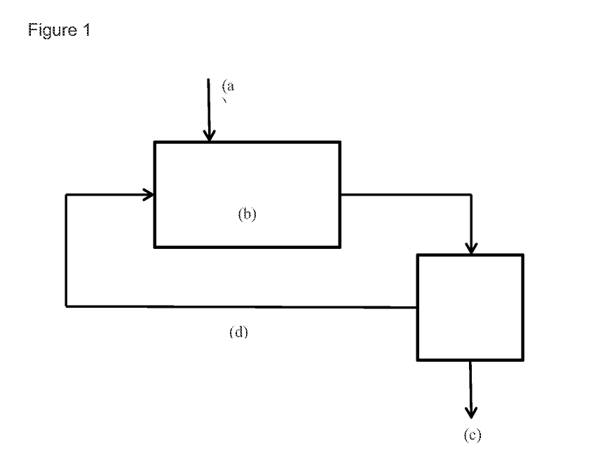

Referring to FIG. 1, a mixed orthophosphate is sprayed into the recycling bed (a) of the kiln (b) at a temperature of 350 C to 550 C. A portion of the product (c) is screened and packed at point (d). The remaining portion of product is recycled back into the kiln (b).

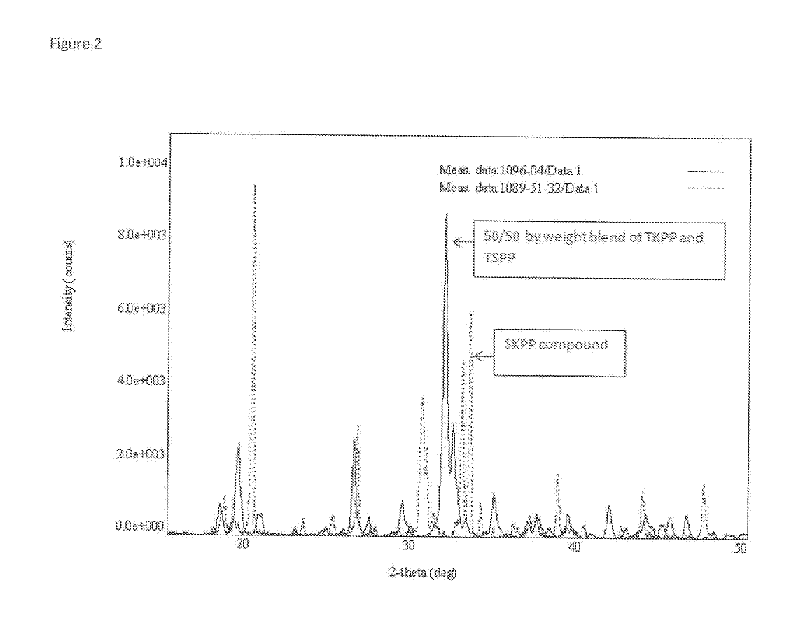

FIG. 2 illustrates the product, a 50/50 blend of TSPP and TKPP, formed by the process of the present invention.

### Example 2

A physical mixture of TKPP (tetrapotassium pyrophosphate) and TSPP (tetrasodium pyrophosphate) at molar ratio of 1:1 was hydrated with 15% water. The hydrated mixture was dried in a rotary dryer (kiln) at 200° C., yielding 93.8% sodium-potassium pyrophosphate and 6.2% mixed sodium and potassium orthophosphate with pH value of 10.25.

### Example 3

The hydrated blend of TSPP and TKPP from example 1 was dried at product temperatures from 345 C to 400 C, yielding 98.55% sodium-potassium pyrophosphate with a pH of 10.25.

### Example 4

Sodium potassium pyrophosphate was prepared by condensing (calcining) sodium potassium orthophosphate mixture directly from solution. Solution of mixed orthophosphate was prepared dissolving NaH2PO4 and adding KOH to the molar ratio of (Na+K)/P of about 2. The solution of sodium potassium orthophosphate was dosed (sprayed) into hot recycled bed of sodium potassium pyrophosphate from Example 2 and calcined at a temperature range from 350°-430° C. The prepared mixed pyrophosphate would have an assay from 97% to 98.97% sodium potassium pyrophosphate.

### Example 5

Solution of TSPP and TKPP was prepared by reacting STPP with NaOH to form TSPP. Into prepared solution TKPP was charged to make a 48.6% solution of sodium potassium pyrophosphate. The solution of sodium potassium pyrophosphate was calcined directly in the rotary dryer (kiln) by dosing into a hot recycled bed of Example 2 at temperature ranges from 340° C. to 390° C.

### Example 6

A starting recirculation bed prepared by direct combining TKPP solution and re-cycled bed of TSPP directly in the kiln. Solution containing 40% to 47% TKPP was sprayed into hot bed of TSPP at product temperatures from 270° C. to 430° C. After reaching a mixture of TKPP and TSPP at molar ratio of 1:1, sodium potassium pyrophosphate was formed. The reaction of formation of the true mixed sodium potassium pyrophosphate occurred at temperatures from 270°-340° C. (below 355° C.) with partial hydrolysis to sodium potassium orthophosphate (below 300° C.). The prepared sodium pyrophosphate would have 95.45% total assay as pyrophosphate, containing only 0.74% as TSPP.

1. A process for preparing a mixed alkali metal pyrophosphate compound having the formula:
X₂Y₂ P₂O₇
wherein X and Y are independently selected from the group consisting of Na, K, Li, and Cs comprising spraying a mixed orthophosphate into a recycling bed of mixed alkali metal pyrophosphates at a kiln temperature of 350 C to 550 C.

2. A process for preparing a mixed alkali metal pyrophosphate compound having the formula:
Na₄K₄(P₂O₇)₂ comprising spraying water into a mixed bed of Na₄P₂O₇ and K₄P₂O₇.
